(19) United States
(12) Patent Application Publication
(10) Pub. No.: US 2026/0227283 A1
(43) Pub. Date: Aug. 6, 2026

(54) ELECTRIC MOTOR SYSTEM LIFE EVALUATION

(71) Applicant: IHI Corporation, Tokyo (JP)

(72) Inventors: Nobuyuki IKEYA, Tokyo (JP); Kenji II, Tokyo (JP); Junichi SUZUKI, Tokyo (JP); Filsinger DIETMAR, Wiesloch (DE)

(21) Appl. No.: 19/650,330

(22) Filed: Apr. 17, 2026

Related U.S. Application Data
(63) Continuation of application No. PCT/JP2024/037063, filed on Oct. 17, 2024.

(30) Foreign Application Priority Data
Oct. 20, 2023 (JP) 2023-180732

(51) Int. Cl. G01M 13/04; H02K 7/08; H02K 11/00; H02K 11/33

(52) U.S. Cl. CPC G01M 13/04; H02K 7/08; H02K 11/0094; H02K 11/33

(57) ABSTRACT

An electric motor system includes a motor, a hydrodynamic air bearing that rotatably supports a shaft of the motor, a power conversion circuit that provides a drive current to the motor, and a controller including a life evaluation module that evaluates a life of the air bearing. The life evaluation module has a data input unit that obtains rotation speed history data which is a time history of a rotation speed of the motor, a sliding distance acquisition unit that obtains, using the rotation speed history data, a sliding distance when the shaft is in a state of rotating while being in contact with the air bearing, and an evaluation value calculation unit that evaluates the life of the air bearing using the sliding distance.

### CROSS-REFERENCE TO RELATED APPLICATIONS

This application is a continuation application of PCT Application No. PCT/JP 2024/037063, filed on Oct. 17, 2024, which claims the benefit of priority from Japanese Patent Application No. 2023-180732, filed on Oct. 20, 2023. The entire contents of the above listed PCT and priority applications are incorporated herein by reference.

### BACKGROUND

### Field

The present disclosure relates to a life evaluation device, a life evaluation method, and a life evaluation program for an electric motor system.

Japanese Unexamined Patent Application Publication No. 2012-12995 discloses a technology handling data regarding the life of a turbocharger. The technology obtains a value obtained by integrating an operation time of an exhaust turbocharger within a resonance rotation speed region based on a turbine rotation speed of the exhaust turbocharger provided in an internal combustion engine.

Japanese Unexamined Patent Application Publication No. 2013-72301 discloses a technology for detecting an abnormality of an electric turbocharger. The technology focuses on a difference between a rated rotation speed and an actual rotation speed of an electric motor. The technology determines whether or not an operation state of the electric motor is abnormal based on the difference between the rated rotation speed and the actual rotation speed.

In a system including an electric motor, deterioration of components occurs due to operation. If a deteriorated component is present, the system falls into a state where it cannot exhibit desired performance. If the deterioration of the component further progresses, the system may fall into a situation where it cannot be operated. Therefore, if the life of the component can be predicted, it becomes possible to perform maintenance work for replacing the component in advance.

### SUMMARY

An example electric motor system may include: a motor including a shaft; a hydrodynamic air bearing that rotatably supports the shaft; an inverter configured to supply a drive current to the motor; and a controller. The controller may be configured to: calculate a sliding distance over which the shaft has rotated while being in contact with the air bearing, based on rotation speed history data that is a time history of a rotation speed of the motor; and calculate a remaining life evaluation value for evaluating a life of the air bearing based on the sliding distance.

### BRIEF DESCRIPTION OF THE DRAWINGS

FIG. 1 is an example schematic diagram showing an electric motor system.

FIG. 2 is an example diagram for explaining a life evaluation function of a controller.

FIG. 3A is an example illustration of rotation speed history data.

FIG. 3B is an example illustration of a change over time in a remaining foil thickness.

FIG. 4 is an example flowchart showing main steps of a life evaluation method.

FIG. 5 is an example diagram for explaining main parameters in the life evaluation method.

FIG. 6 is an example diagram for explaining functional components of the controller.

FIG. 7 is an example illustration of a physical configuration of the controller.

FIG. 8 is an example schematic diagram showing an additional electric motor system.

FIG. 9 is an example schematic diagram showing a further additional electric motor system of still another modification.

### DETAILED DESCRIPTION

In the following description, with reference to the drawings, the same reference numbers are assigned to the same components or to similar components having the same function, and overlapping description is omitted.

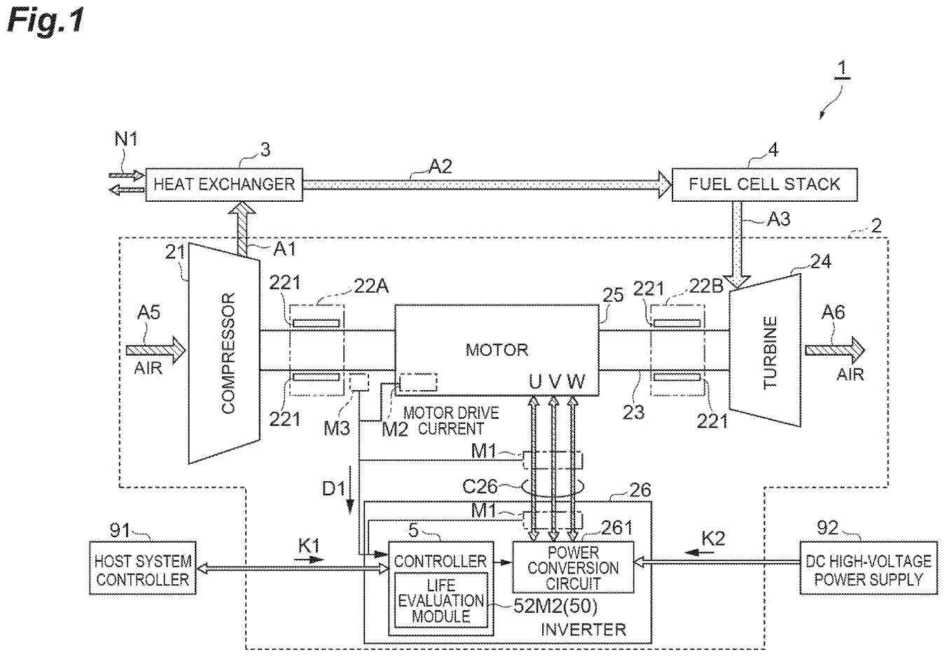

FIG. 1 is an example schematic diagram showing an electric motor system 1. The electric motor system 1 includes an electric turbocharger 2, a heat exchanger 3, and a fuel cell stack 4. The electric motor system 1 may be mounted on a fuel cell vehicle. The electric turbocharger 2 outputs high-temperature and high-pressure air A1 to the heat exchanger 3. The heat exchanger 3 lowers a temperature of the air A1 to a predetermined temperature by a refrigerant N1. The heat exchanger 3 outputs air A2 whose temperature has been lowered to the fuel cell stack 4. The fuel cell stack 4 generates electric power by causing oxygen contained in the air A2 to react with separately supplied hydrogen. The fuel cell stack 4 outputs air A3 after reaction to the electric turbocharger 2. The electric turbocharger 2 uses the air A3 received from the fuel cell stack 4 as part of the driving force.

The electric motor system 1 may include the fuel cell stack 4 as a component that receives the air A1 generated by the electric turbocharger 2. A supply destination of the air A1 generated by the electric turbocharger 2 may be not limited to the fuel cell stack 4.

The electric turbocharger 2 outputs compressed air A1. The electric turbocharger 2 has a compressor 21 for compressing sucked air A5. By rotation of the compressor 21, the air A5 that has passed through a filter is sucked in, and the compressed air A1 is output. A first end of a shaft 23 is connected to the compressor 21. The shaft 23 rotates by receiving a driving force from a turbine 24 connected to a second end of the shaft 23. The shaft 23 also receives a driving force from a motor 25 disposed between the compressor 21 and the turbine 24.

The motor 25 receives a drive current C26 from an inverter 26. The drive current C26 is a so-called three-phase alternating current including a U-phase, a V-phase, and a W-phase. The inverter 26 converts a high-voltage direct current K2 received from a DC high-voltage power supply 92 into a three-phase alternating current required by the motor 25. The inverter 26 may obtain phase information of the shaft 23 using the drive current C26. The phase information may be converted into information on a rotation speed. The inverter 26 controls the motor 25 using several internal variables. The internal variables may be an output voltage of the DC high-voltage power supply 92, an output current of the DC high-voltage power supply 92, the drive current of the motor 25, a drive voltage of the motor 25, a rotation phase of the motor 25, and the rotation speed of the motor 25.

The inverter 26 communicates with a host system controller 91 of the electric turbocharger 2. The inverter 26 may receive an operation control signal K1 from the host system controller 91. A protocol for communication between the inverter 26 and the host system controller 91 may be a so-called CAN (Controller Area Network), or may be another protocol. The inverter 26 increases or decreases a motor output using a difference between a command value of the rotation speed from the host system controller 91 and an actual rotation speed of the shaft 23. As a result, the rotation speed of the shaft 23 is controlled so as to become the command value of the rotation speed from the host system controller 91. During the control, the voltage and current given from the DC high-voltage power supply 92 are measured. As a result, optimal driving of the motor 25 can be performed.

The inverter 26 includes a power conversion circuit 261 (power conversion unit) for converting electric power, and a controller 5 that controls an operation of the power conversion circuit 261. The power conversion circuit 261 is configured by a plurality of switching elements. The controller 5 converts the direct current K2 received from the DC high-voltage power supply 92 into the drive current C26 by controlling the ON/OFF status of the plurality of switching elements.

The shaft 23 is supported by two air bearings 22A and 22B. The air bearing 22A is disposed between the compressor 21 and the motor 25. The air bearing 22B is disposed between the motor 25 and the turbine 24. The positional relationship between the motor 25 and the air bearings 22A and 22B may not be limited.

The air bearings 22A and 22B may be hydrodynamic air bearings that support the shaft 23 in rotation in a non-contact state. The air bearings 22A and 22B may receive a radial load along a radial direction of the shaft 23. The air bearings 22A and 22B may be foil bearings. The foil bearing has a foil 221 disposed so as to surround an outer peripheral surface of the shaft 23. An air film is formed between the outer peripheral surface of the rotating shaft 23 and a main surface of the foil 221. Since a slight gap is formed between the outer peripheral surface of the shaft 23 and the main surface of the foil 221 by the air film, the outer peripheral surface of the shaft 23 and the main surface of the foil 221 do not directly contact each other.

The air bearings 22A and 22B support the shaft 23 in a non-contact manner when the rotation speed of the shaft 23 is higher than a so-called contact rotation speed. Therefore, when the shaft 23 is in a stopped state where the shaft 23 is not rotating, the shaft 23 and the foil 221 are in contact. When the shaft 23 starts rotating from the contact state, the outer peripheral surface of the shaft 23 rotates while rubbing against the main surface of the foil 221. Then, when the rotation speed of the shaft 23 exceeds the contact rotation speed, the shaft 23 floats, so that a state of non-contact support is established. When the rotation speed of the shaft 23 falls below the contact rotation speed, the outer peripheral surface of the shaft 23 contacts the main surface of the foil 221 again. In the contact state, the rotation speed of the shaft 23 further decreases, and as a result, the rotation of the shaft 23 stops. Thus, the states of the air bearings 22A and 22B and the shaft 23 include a state of rotating while rubbing against each other and a state of rotating without contacting each other.

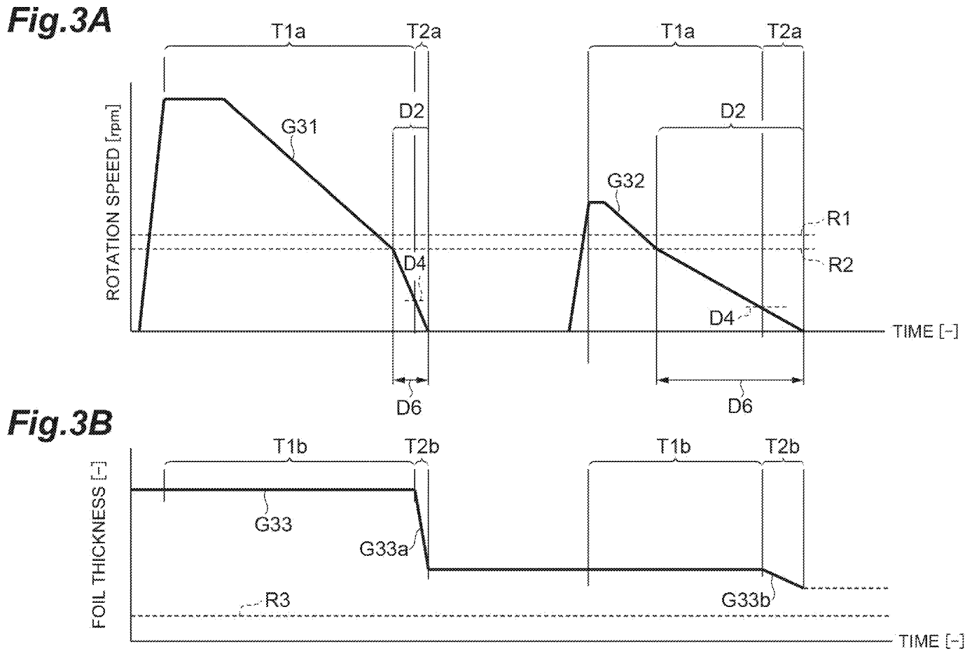

When the shaft 23 rotates while rubbing against the foils 221 of the air bearings 22A and 22B, wear of the foils 221 occurs. Since the foil 221 is a thin plate-shaped component, when a thickness of the foil 221 falls below a predetermined thickness (see reference sign R3 in FIG. 3B), the foil 221 is replaced. That is, the foil 221 is one of the elements that determine an operable period of the air bearings 22A and 22B. If a replacement timing of the foil 221 can be predicted in advance, it becomes possible to operate the electric turbocharger 2 and the electric motor system 1 including the electric turbocharger 2. In the electric motor system 1 of the present disclosure, the timing at which the foil 221 should be replaced is defined as the life of the air bearings 22A and 22B, and the timing at which the foil 221 should be replaced is obtained. Since the air bearings 22A and 22B are components of the electric turbocharger 2, it can be said that the life of the air bearings 22A and 22B is the life of the electric turbocharger 2. Since the electric turbocharger 2 is a component of the electric motor system 1, it can be said that the life of the air bearings 22A and 22B is the life of the electric motor system 1.

Hereinafter, an example for evaluating the life will be described.

The electric motor system 1 shown in FIG. 1 evaluates the life by the controller 5 provided in the inverter 26. The controller 5 evaluates the life of the air bearings 22A and 22B using rotation speed history data D1 of the shaft 23. The rotation speed history data D1 may be obtained using an output of a current sensor M1 that measures the drive current C26 provided from the inverter 26 to the motor 25. The current sensor M1 may be a component of the inverter 26. The current sensor M1 may be a component provided on a power line connecting the inverter 26 and the motor 25.

The rotation speed history data D1 may be obtained using outputs of other sensors. A motor sensor M2 is a component of the motor 25 and outputs data regarding a rotation speed of a rotor provided in the motor 25. The motor sensor M2 may utilize an induced current generated in a coil of a stator due to rotation of the rotor. The motor sensor M2 may directly measure the rotation of the rotor. A rotation speed sensor M3 is a component of the electric turbocharger 2 and may directly measure the rotation of the shaft 23.

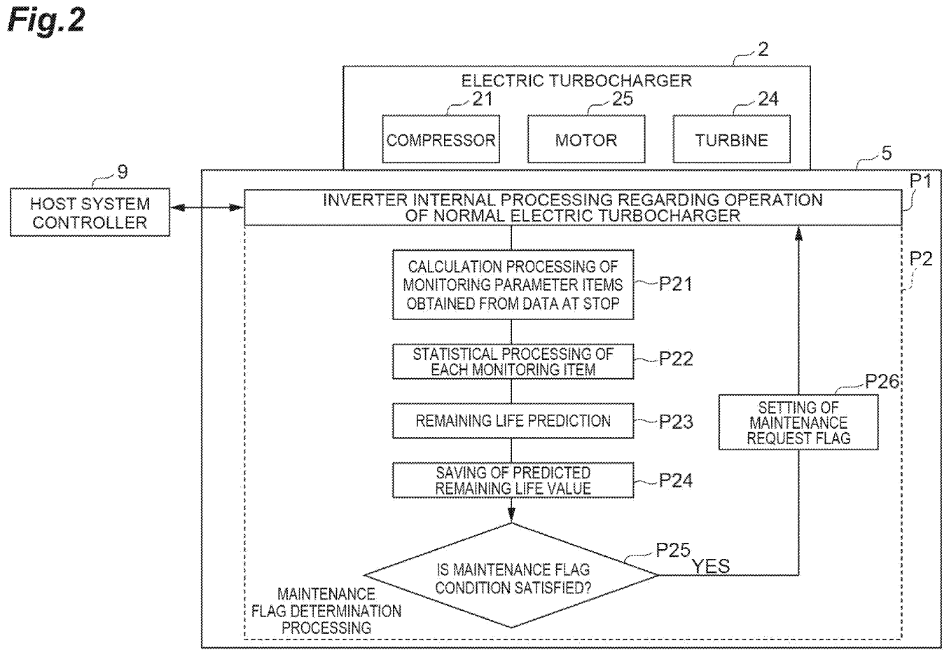

FIG. 2 schematically shows an example operation of the controller 5. The controller 5 mainly performs two processes. A first process P1 is control of the inverter 26 regarding normal operation of the electric turbocharger 2. In the first process P1, a control signal for the switching elements provided in the power conversion circuit 261 is generated.

A second process P2 is a maintenance request flag determination. In the second process P2, several monitoring parameters may be obtained based on the rotation speed history data D1 when the motor 25 is stopped (P21). Next, statistical processing of each monitoring parameter is performed (P22). Next, a remaining life is predicted (P23). For the prediction of the remaining life, coefficients obtained using an operation status of the electric turbocharger 2 and evaluation results accumulated in advance are used. Next, a predicted value of the remaining life is saved (P24).

Then, determination of the remaining life is performed (P25). In the determination of the remaining life, it is determined whether or not a maintenance request flag condition is satisfied. When it is determined that the maintenance request flag condition is satisfied, a maintenance request flag is set (P26).

Subsequently, an example of life evaluation will be described. It has already been mentioned that the remaining life is obtained using the history of the rotation speed. First, several parameters for evaluating the remaining life will be described. Next, a method for evaluating the remaining life using those parameters will be described. Then, the controller 5 that executes the life evaluation method will be described.

FIG. 3A is an example illustration of the rotation speed history data D1. FIG. 3B is an example illustration of a change over time in the remaining foil thickness. The rotation speed history data D1 is composed of time and rotation speed. When the operation of the electric turbocharger 2 in the stopped state is started, the rotation speed increases. The rotation speed increases or decreases in response to a request from the outside. In the example of a graph G31 in FIG. 3A, after reaching a predetermined rotation speed, the predetermined rotation speed is maintained for a certain period of time. Thereafter, the rotation speed gradually decreases and reaches zero. The example of the graph G31 is an example where the electric turbocharger 2 operates at a high rotation speed. Since the maximum rotation speed is high, a required stop time D6 from the maximum rotation speed to zero tends to be short. The example of the graph G31 may include a state where the rotation speed fluctuates in a short time (load fluctuation state).

An idle rotation speed R1 is presented. The idle rotation speed R1 may be defined as the rotation speed of the shaft 23 when the supply of the air A2 from the electric turbocharger 2 to the fuel cell stack 4 is in a minimum state. A specified upper limit rotation speed R2 (predetermined rotation state) is presented. The specified upper limit rotation speed R2 is equal to or lower than the idle rotation speed R1. The specified upper limit rotation speed R2 is greater than zero. In the following description, data included in a range of rotation speeds smaller than the specified upper limit rotation speed R2 is referred to as target rotation speed history data D2. The required stop time D6 is presented. The required stop time D6 is defined as a time from the specified upper limit rotation speed R2 until the rotation speed reaches zero.

A contact rotation speed D4 is presented. It has already been mentioned that the air bearings 22A and 22B are hydrodynamic bearings. The contact rotation speed D4 may be defined as a rotation speed at which a state switches from non-contact state to the contact state as the rotation speed of the shaft 23 gradually decreases while the shaft 23 is rotating in the non-contact state. The contact rotation speed D4 is smaller than the idle rotation speed R1. The contact rotation speed D4 may be smaller than the specified upper limit rotation speed R2. The contact rotation speed D4 is affected by the operation status of the electric turbocharger 2. It may be assumed that the contact rotation speed D4 changes within a predetermined range according to the operation status of the electric turbocharger 2.

It has already been mentioned that the foils 221 provided in the air bearings 22A and 22B are worn by the shaft 23 rotating while being in contact. In the graph G31 of FIG. 3A, in a period where the rotation speed is higher than the contact rotation speed D4 (non-contact period T1a), since the shaft 23 is not in contact with the foils 221, it may be assumed that wear of the foils 221 does not occur. Therefore, in a graph G33 of FIG. 3B, in a period T1b corresponding to the non-contact period T1a, since wear of the foils 221 does not occur, it may be assumed that the thickness of the foils 221 is constant.

In the graph G31 of FIG. 3A, in a period where the rotation speed is lower than the contact rotation speed D4 (contact period T2a), since the shaft 23 is in contact with the foils 221, it may be assumed that wear of the foils 221 occurs. Therefore, in a graph G33a of FIG. 3B, in a period T2b corresponding to the contact period T2a, it may be assumed that wear of the foils 221 occurs and the thickness of the foil 221 gradually decreases.

The example of a graph G32 in FIG. 3A) is an example where the electric turbocharger 2 operates at a low rotation speed. The example of the graph G32 may include a steady operation state where the electric turbocharger 2 operates at a constant rotation speed. In the case of low rotation speed operation and low load operation, the required stop time D6 until the rotation speed reaches zero tends to be long.

### Life Evaluation Method

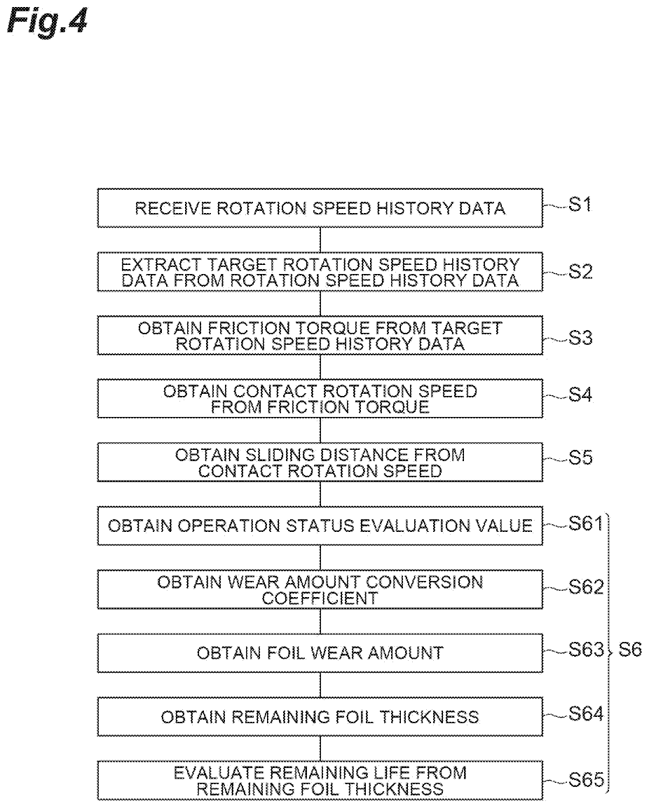

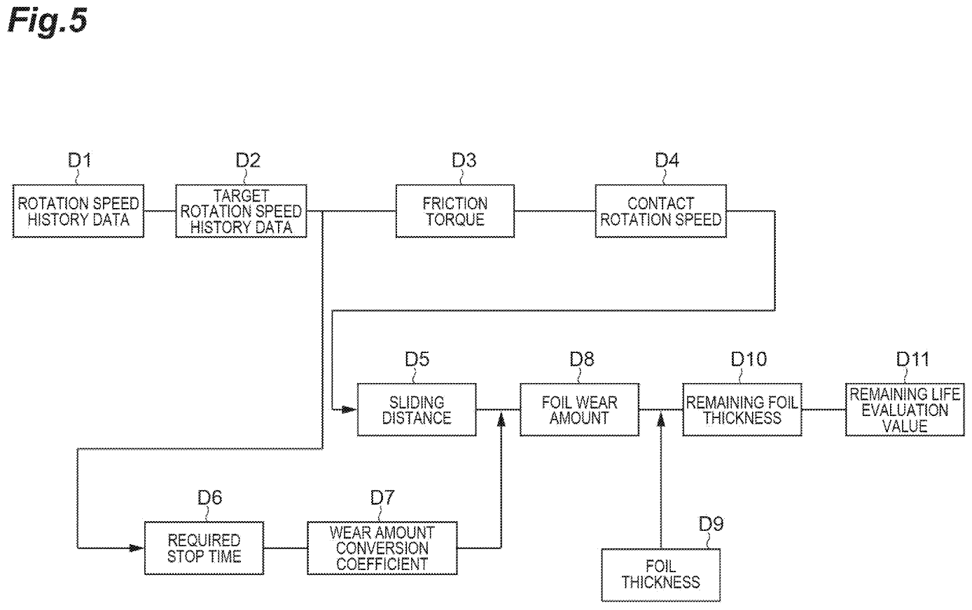

FIG. 4 is an example flowchart of the life evaluation method. FIG. 5 is an example conceptual diagram showing a flow of parameters until a remaining life evaluation value D11 is obtained from the rotation speed history data D1 in the life evaluation method.

First, the controller 5 receives the rotation speed history data D1 (S1). The controller 5 receives the rotation speed history data D1 from the current sensor M1, the motor sensor M2, the rotation speed sensor M3, and the like. Next, the controller 5 extracts the target rotation speed history data D2 from the rotation speed history data D1 (S2). The controller 5 extracts a range from the specified upper limit rotation speed R2 to zero rotation speed in the rotation speed history data D1 as the target rotation speed history data D2.

Next, the controller 5 obtains a friction torque D3 from the target rotation speed history data D2 (S3). Subsequently, the controller 5 obtains the contact rotation speed D4 from the friction torque D3 (S4). The air bearings 22A and 22B may take a state where the shaft 23 rotates in contact and a state where the shaft 23 rotates without contact. The friction torque D3 generated between the foil 221 and the shaft 23 when the shaft 23 is in the state of rotating in contact is different from the friction torque D3 generated between the foil 221 and the shaft 23 when the shaft 23 is in the state of rotating without contact. For example, when the rotation speed of the shaft 23 decreases and the state switches from the state of rotating without contact to the state where the shaft 23 rotates in contact, the friction torque D3 may change discontinuously. Thus, since there is a relationship between the rotation state of the shaft 23 and the friction torque D3, the contact rotation speed D4 can be obtained from the friction torque.

Next, a sliding distance D5 is obtained (S5). The sliding distance D5 is a distance over which the shaft 23 rotates while rubbing against the foil 221 during a period from the contact rotation speed D4 until the rotation speed becomes zero. The controller 5 obtains the sliding distance D5 using a time history of the rotation speed from the contact rotation speed D4 until the rotation speed becomes zero and physical dimension values such as a diameter of the shaft 23.

Incidentally, it has already been mentioned that the life evaluation method evaluates the life based on the thickness of the foil 221. The wear amount of the foil 221 generated by the rubbing between the shaft 23 and the foil 221 is defined as a function of the sliding distance D5. As the sliding distance D5 becomes longer, the wear amount of the foil 221 increases. If the wear amount of the foil 221 can be calculated, the thickness of the remaining foil 221 (remaining foil thickness D10) can be obtained. By using the remaining foil thickness D10, the life of the foil 221 can be evaluated.

In the life evaluation method, an operation status of the electric turbocharger 2 is considered for a coefficient for converting the sliding distance D5 into the wear amount of the foil 221. The longer the sliding distance D5 is, the larger the wear amount of the foil 221 is, but the wear amount of the foil 221 per unit length of sliding distance D5 is affected by the operation status of the electric turbocharger 2. When the operation status during the period when the shaft 23 and the foil 221 are not in contact (see period T1a in FIG. 3A) is high load and/or high rotation speed, the wear amount of the foil 221 per unit length of sliding distance D5 tends to increase. In FIG. 3B, under an operation status of high rotation and high load, the speed of wear is high, and it can be represented that the slope becomes steep as shown in the graph G33a. Conversely, when the operation status up to that point is low load and/or constant load, the wear amount of the foil 221 per unit length of sliding distance D5 tends to decrease. In FIG. 3B, under an operation status of low rotation and low load, the speed of wear is slow, and it can be represented that the slope becomes gradual as shown in a graph G33b. The life evaluation method of the present disclosure not only simply converts the sliding distance D5 into the wear amount of the foil 221, but also reflects the influence of the operation status on the coefficient for converting the sliding distance D5 into the wear amount of the foil 221.

Next, the controller 5 obtains the remaining life evaluation value D11 using the sliding distance D5 (S6). First, the controller 5 obtains an operation status evaluation value (S61). The operation status evaluation value is a value that determines whether the operation status up to that point can be defined as high load and/or high rotation speed, or can be defined as low load and/or constant load. The operation status evaluation value may define two operation statuses. The operation status evaluation value may define three or more operation statuses. An example of the operation status evaluation value may include the required stop time D6. This is because the shorter the required stop time D6 is, the higher the possibility that the operation status up to that point was high load and/or high rotation speed. Additional example of the operation status evaluation value may include the contact rotation speed D4. The operation status evaluation value may be defined by the required stop time D6, or may be defined by the contact rotation speed D4. The operation status evaluation value may be defined using both the required stop time D6 and the contact rotation speed D4.

The operation status evaluation value may include the required stop time D6 obtained every time the rotation speed becomes zero. The operation status evaluation value may include the contact rotation speed D4 obtained every time the rotation speed becomes zero. The operation status evaluation value may be obtained using a plurality of values obtained based on a plurality of required stop times D6 obtained in the past. The operation status evaluation value may be obtained using a plurality of values obtained based on a plurality of contact rotation speeds D4 obtained in the past. The operation status evaluation value may include an average value of a plurality of required stop times D6 obtained in the past. The operation status evaluation value may include an average value of a plurality of contact rotation speeds D4 obtained in the past. The operation status evaluation value may include a standard deviation of a plurality of required stop times D6 may be used. The operation status evaluation value may include a standard deviation of a plurality of contact rotation speeds D4 may be used.

Next, the controller 5 obtains a wear amount conversion coefficient D7 (S62). The controller 5 may determine a coefficient for converting the sliding distance D5 into the wear amount of the foil 221 by setting a threshold value in advance and comparing the threshold value with the required stop time D6. This coefficient for converting the sliding distance D5 into the wear amount of the foil 221 is referred to as the wear amount conversion coefficient D7.

Next, the controller 5 obtains a foil wear amount D8 (S63). The controller 5 obtains the foil wear amount D8 by multiplying the sliding distance D5 by the wear amount conversion coefficient D7. Next, the controller 5 obtains the remaining foil thickness D10 (S64). The controller 5 reads a foil thickness D9 obtained in the previous process. Then, the controller 5 subtracts the foil wear amount D8 from the read foil thickness D9. As a result, the remaining foil thickness D10 is obtained.

Then, the controller 5 evaluates the remaining life evaluation value D11 (S65). The remaining life evaluation value D11 is a condition until reaching the thickness of the foil 221 for which the maintenance request flag should be set (see reference sign R3 in FIG. 3B). The remaining life evaluation value D11 may be defined by the number of contacts until reaching the thickness of the foil 221 for which the maintenance request flag should be set. The remaining life evaluation value D11 may be defined by a time until reaching the thickness of the foil 221 for which the maintenance request flag should be set. The remaining life evaluation value D11 may be defined by a sliding distance (rotation speed) until reaching the thickness of the foil 221 for which the maintenance request flag should be set.

### Life Evaluation Device

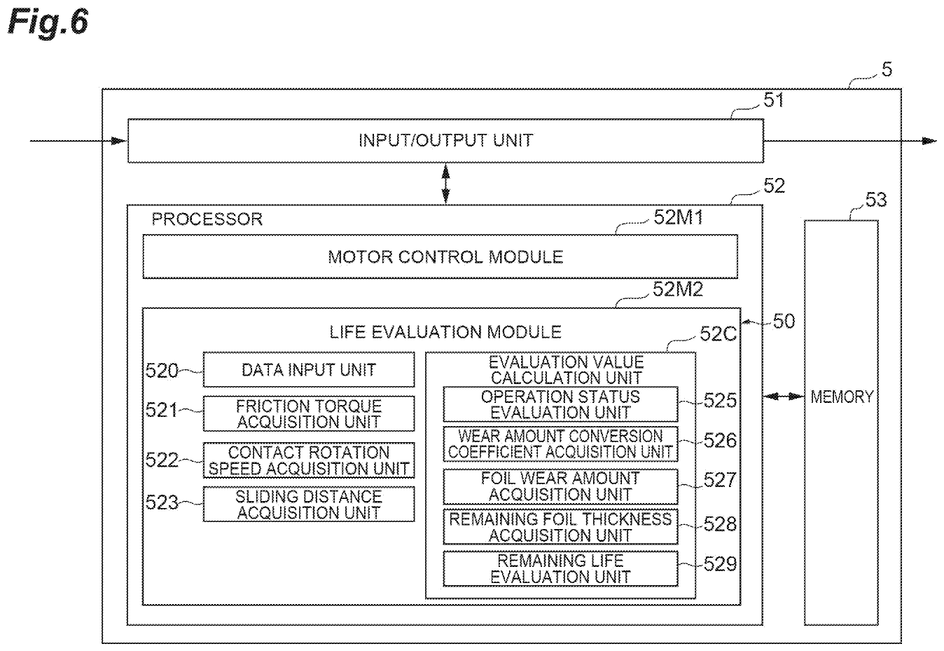

Next, the controller 5 including functions of a life evaluation device 50 that executes the life evaluation method will be described. As shown in FIG. 6, the controller 5 is physically a computer including an input/output unit 51, a processor 52, a memory 53, and the like. By the processor 52 executing a life evaluation program PG2 recorded in the memory 53, functional elements constituting the life evaluation device 50 are realized.

The input/output unit 51 receives predetermined data from, for example, the host system controller 91 or the like, and outputs predetermined data to the host system controller 91 or the like. The input/output unit 51 outputs a control signal for controlling the switching elements to the power conversion circuit 261. The input/output unit 51 receives the rotation speed history data D1 from the current sensor M1 or the like. The input/output unit 51 passes the received data to the processor 52 and receives a calculation result of the processor 52. The input/output unit 51 may pass data received from the outside of the controller 5 to the processor 52 and receives a calculation result of the processor 52.

The processor 52 is connected to the input/output unit 51. The processor 52 receives predetermined data from the input/output unit 51 and outputs a calculation result to the input/output unit 51. The processor 52 is connected to the memory 53. The processor 52 receives predetermined data and programs from the memory 53 and outputs a calculation result to the memory 53.

The memory 53 stores various programs required for the operation of the electric turbocharger 2, such as the life evaluation program PG2 and a rotation control program. The memory 53 temporarily or permanently stores various parameters used in the life evaluation method. The memory 53 is connected so as to be accessible from the processor 52.

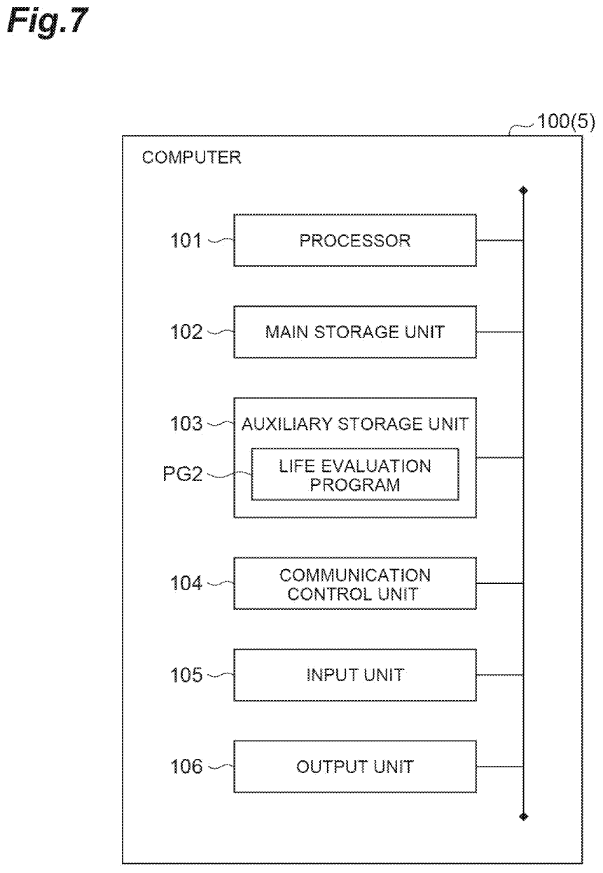

The physical configuration of the controller 5 may not be limited to the configuration shown in FIG. 6. The controller 5 may adopt a configuration as shown in FIG. 7.

The controller 5 is configured by a computer 100. The computer 100 includes a processor 101 which is a CPU (Central Processing Unit), a main storage unit 102, an auxiliary storage unit 103, an external communication unit 104, an operation unit 105, and an output unit 106. The processor 101 in FIG. 7 corresponds to the processor 52 in FIG. 6. The main storage unit 102 and the auxiliary storage unit 103 in FIG. 7 correspond to the memory 53 in FIG. 6. The external communication unit 104, the operation unit 105, and the output unit 106 in FIG. 7 correspond to the input/output unit 51 in FIG. 6. The controller 5 may be constituted by one computer 100 or a plurality of computers 100 configured with these pieces of hardware and software such as programs.

When the controller 5 is configured by the plurality of computers 100, the plurality of computers 100 may be connected locally, or may be connected via a communication network such as the Internet or an intranet. By this connection, one controller 5 is logically constructed.

The processor 101 executes an operating system, application programs, and the like. The main storage unit 102 is configured by a ROM (Read Only Memory) and a RAM (Random Access Memory). The auxiliary storage unit 103 is a storage medium configured by a hard disk, a flash memory, or the like. The auxiliary storage unit 103 generally stores a larger amount of data than the main storage unit 102.

The life evaluation program PG2 causes the computer 100 to function as each functional element of the controller 5. The life evaluation program PG2 may be read by the processor 101 or the main storage unit 102, and operates at least one of the processor 101, the main storage unit 102, the auxiliary storage unit 103, the external communication unit 104, the operation unit 105, and the output unit 106. The life evaluation program PG2 may perform reading and writing of data in the main storage unit 102 and the auxiliary storage unit 103.

The life evaluation program PG2 may be provided in a state of being recorded on a tangible recording medium such as a CD-ROM, a DVD-ROM, or a semiconductor memory. The life evaluation program PG2 may be provided as a data signal via a communication network.

The controller 5 may be configured by various types of hardware When the controller 5 is configured as an embedded system, the controller 5 may include hardware that includes the main storage unit 102 but does not include the auxiliary storage unit 103. In this case, the life evaluation program PG2 may be stored in the main storage unit 102. When the controller 5 includes the auxiliary storage unit 103, various data used for life evaluation may be stored in the auxiliary storage unit 103. Data used for life evaluation tends to have a large data capacity. Since the auxiliary storage unit 103 has a larger storable data capacity than the main storage unit 102, it is possible to store more data used for life evaluation. The data used for life evaluation may be transmitted to and stored in an external server via the external communication unit 104. The data used for life evaluation may be transmitted to and stored in a cloud via the external communication unit 104.

Reference is made to FIG. 6 again. The controller 5 includes a motor control module 52M1 and a life evaluation module 52M2 as functional elements. The motor control module 52M1 outputs a control signal for the power conversion circuit 261. The life evaluation module 52M2 outputs the remaining life evaluation value D11.

The life evaluation module 52M2 (life evaluation unit) has a data input unit 520, a friction torque acquisition unit 521, a sliding distance acquisition unit 523, a contact rotation speed acquisition unit 522, and an evaluation value calculation unit 52C.

The data input unit 520 receives the rotation speed history data D1 from the input/output unit 51. The data input unit 520 executes the operation (S1) of receiving the rotation speed history data D1 in the life evaluation method.

The friction torque acquisition unit 521 receives the rotation speed history data D1 and outputs the friction torque D3. The friction torque acquisition unit 521 executes the operation (S3) of obtaining the friction torque D3 from the target rotation speed history data D2 in the life evaluation method.

The contact rotation speed acquisition unit 522 receives the friction torque D3 and outputs the contact rotation speed D4. The contact rotation speed acquisition unit 522 executes the operation (S4) of obtaining the contact rotation speed D4 from the friction torque D3 in the life evaluation method.

The sliding distance acquisition unit 523 receives the rotation speed history data D1, the contact rotation speed D4, the dimension values of the shaft 23, and the like, and outputs the sliding distance D5. The sliding distance acquisition unit 523 executes the operation (S5) of obtaining the sliding distance D5 in the life evaluation method.

The evaluation value calculation unit 52C receives the sliding distance D5 and the like, and outputs the remaining life evaluation value D11. The evaluation value calculation unit 52C executes the operation (S6) of evaluating the life in the life evaluation method. The evaluation value calculation unit 52C includes, as functional components for obtaining the remaining life evaluation value D11, an operation status evaluation unit 525, a wear amount conversion coefficient acquisition unit 526, a foil wear amount acquisition unit 527, a remaining foil thickness acquisition unit 528, and a remaining life evaluation unit 529.

The operation status evaluation unit 525 receives the rotation speed history data D1 and outputs the required stop time D6 as the operation status evaluation value. The operation status evaluation unit 525 executes the operation (S61) of obtaining the operation status evaluation value in the life evaluation method.

The wear amount conversion coefficient acquisition unit 526 receives the required stop time D6 as the operation status evaluation value and outputs the wear amount conversion coefficient D7. The wear amount conversion coefficient acquisition unit 526 executes the operation (S62) of obtaining the wear amount conversion coefficient D7 in the life evaluation method.

The foil wear amount acquisition unit 527 receives the sliding distance D5 and the wear amount conversion coefficient D7 and outputs the foil wear amount D8. The foil wear amount acquisition unit 527 executes the operation (S63) of obtaining the foil wear amount D8 in the life evaluation method.

The remaining foil thickness acquisition unit 528 receives the foil thickness D9 and the foil wear amount D8 and outputs the remaining foil thickness D10. The remaining foil thickness acquisition unit 528 executes the operation (S64) of obtaining the remaining foil thickness D10 in the life evaluation method.

The remaining life evaluation unit 529 receives the remaining foil thickness D10 and outputs the remaining life evaluation value D11. The remaining life evaluation unit 529 executes the operation (S65) of evaluating the remaining life evaluation value D11 in the life evaluation method.

The energy balance for the motor 25 may be shown by the following equation (1).

$$Compressor driving force - Turbine output + Shaft system mechanical loss - Motor output = - Rotating system moment of inertia \times Angular acceleration \qquad ( 1 )$$

At the time of startup where the rotation speed is low or stop, the outputs of the compressor 21 and the turbine 24 as aerodynamic machines can be treated as sufficiently low. At the time of startup where the rotation speed is low, the rotation speed may vary from zero to the idle rotation speed. At the time of stop, the rotation speed may vary from the idle rotation speed to zero. The rotating system moment of inertia is a design value. The rotating system moment of inertia does not change according to the operation status. Therefore, the change in the rotation speed of the motor 25 (angular acceleration) indicates the shaft system mechanical loss and the motor output. When the shaft 23 is supported by the air bearings 22A and 22B, a change in that state appears in a low rotation speed range.

In equation (1), the term of the shaft system mechanical loss can be expressed as “shaft system mechanical loss=friction torque×angular velocity”. The term of the shaft system mechanical loss includes a loss caused by friction with the shaft 23 generated in the air bearings 22A and 22B, and a loss caused by friction with air on the surface of the rotating part. In an operation state where the rotation speed is low, it is considered that the loss caused by friction with the shaft 23 generated in the air bearings 22A and 22B is dominant. In an operation state where the rotation speed is high, since an air film is formed between the foils 221 of the air bearings 22A and 22B and the shaft 23, the loss is small.

By observing the rotation speed and the rate of change of the rotation speed, it becomes possible to evaluate the state of friction in the air bearings 22A and 22B. In a state where the drive current to the motor 25 is stopped (when the motor 25 is stopped), since the motor 25 is not in a driving state, the effect of the shaft system mechanical loss may be mainly observable. Therefore, the state of the air bearings 22A and 22B may be evaluated using the rotation speed history data D1.

The electric motor system 1 may include the motor 25, the hydrodynamic air bearings 22A and 22B that rotatably support the shaft 23 of the motor 25, the power conversion circuit 261 that provides the drive current C26 to the motor 25, and the controller 5 that controls the operation of the power conversion circuit 261.

The controller 5 may include the data input unit 520 that obtains the rotation speed history data D1 which is a time history of the rotation speed of the motor 25, the sliding distance acquisition unit 523 that obtains, using the rotation speed history data D1, the sliding distance D5 when the shaft 23 is in the state of rotating while being in contact with the air bearings 22A and 22B, and the evaluation value calculation unit 52C that evaluates the life of the air bearings 22A and 22B using the sliding distance D5.

The life evaluation method may include step S1 of obtaining the rotation speed history data D1 which is a time history of the rotation speed of the motor 25, step S5 of obtaining, using the rotation speed history data D1, the sliding distance D5 when the shaft 23 is in the state of rotating while being in contact with the air bearings 22A and 22B, and step S6 of evaluating the life of the air bearings 22A and 22B using the sliding distance D5.

The life evaluation program PG2 may cause the computer 100 to operate as the data input unit 520 that obtains the rotation speed history data D1 which is a time history of the rotation speed of the motor 25, the sliding distance acquisition unit 523 that obtains, using the rotation speed history data D1, the sliding distance D5 when the shaft 23 is in the state of rotating while being in contact with the air bearings 22A and 22B, and the evaluation value calculation unit 52C that evaluates the life of the air bearings 22A and 22B using the sliding distance D5.

According to the electric motor system 1, the controller 5 operating the life evaluation device 50, the life evaluation method, and the life evaluation program PG2, the sliding distance D5 when the shaft 23 is in the state of rotating while being in contact with the air bearings 22A and 22B is calculated. The controller 5 evaluates the life of the air bearings 22A and 22B using the sliding distance D5. Therefore, the life of the system including the electric motor caused by the air bearings 22A and 22B is evaluated.

The electric motor system 1, the controller 5 operating the life evaluation device 50, the life evaluation method, and the life evaluation program PG2 may obtain the contact rotation speed D4, the friction torque D3, the sliding distance D5, and the required stop time D6 by measurement or calculation. By using the average and/or standard deviation of these parameters, the operation status of the electric turbocharger 2 may be estimated. By using the estimated operation status and data obtained in advance by evaluation tests or the like, the wear amount of the foils 221 may be estimated. As a result, since the remaining life evaluation value D11 may be obtained, the timing of maintenance may be predicted.

The air bearings 22A and 22B may have the foils 221 with a thin-plate shape surrounding the shaft 23, and rotatably support the shaft 23 by a gas film formed between the shaft 23 in rotation and the foils 221. The evaluation value calculation unit 52C may include the remaining foil thickness acquisition unit 528 that obtains the remaining foil thickness D10 based on the foil wear amount D8 caused by rotation of the shaft 23 while being in contact with the air bearings 22A and 22B as the rotation speed of the shaft 23 decreases. Accordingly, the life may be evaluated by using the thickness of the foils 221.

The evaluation value calculation unit 52C may include the wear amount conversion coefficient acquisition unit 526 that obtains the wear amount conversion coefficient D7 for converting the sliding distance D5 into the foil wear amount D8 when the foil wear amount D8 is defined as a function having the sliding distance D5 as a variable. Accordingly, the foil wear amount D8 can be obtained from the sliding distance D5 when the foil wear amount D8 is defined as a function having the sliding distance D5 as a variable.

The wear amount conversion coefficient acquisition unit 526 may obtain the wear amount conversion coefficient D7 based on at least one of the required stop time D6 required until the rotation of the shaft 23 stops after transitioning from the state where the drive current C26 is provided from the power conversion circuit 261 to the motor 25 to the state where the drive current C26 is stopped, and the contact rotation speed D4 which is a rotation speed at which the shaft 23 whose rotation speed decreases starts to contact the foils 221 in the state where the drive current C26 is stopped. Accordingly, the operation status may be reflected in the calculation of the foil wear amount D8.

The controller 5 may further include the friction torque acquisition unit 521 that obtains data regarding the friction torque between the air bearings 22A and 22B and the shaft 23 in a range of a specified rotation speed using the rotation speed history data D1, and the contact rotation speed acquisition unit 522 that obtains the contact rotation speed D4 using the friction torque D3 and the rotation speed history data D1. Accordingly, the contact rotation speed D4 for obtaining the sliding distance D5 may be obtained.

It is to be understood that not all aspects, advantages and features described herein may necessarily be achieved by, or included in, any one particular example. Indeed, having described and illustrated various examples herein, it should be apparent that other examples may be modified in arrangement and detail.

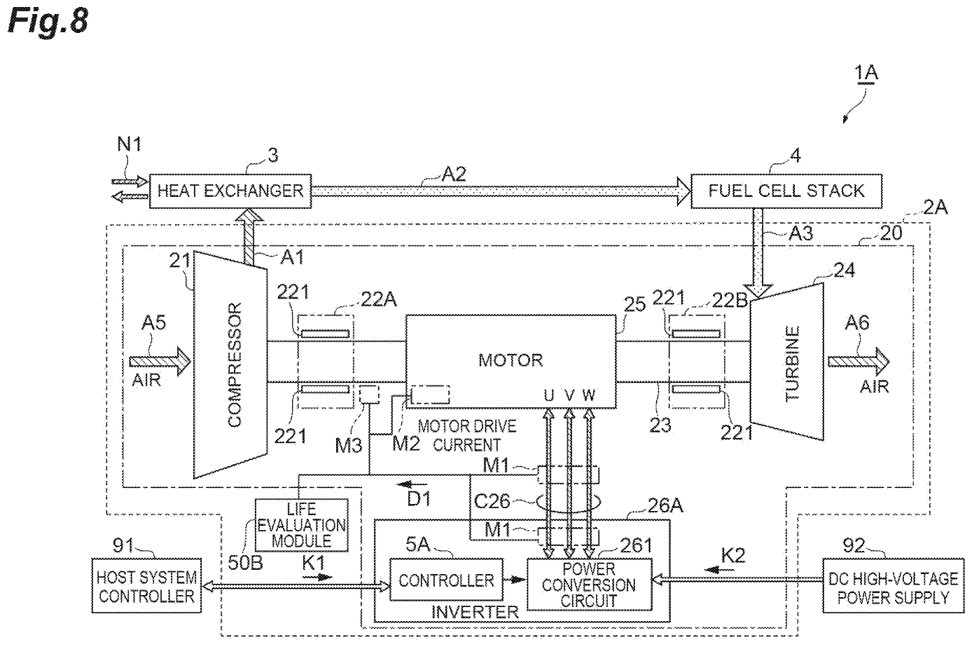

An electric turbocharger 2A of an electric motor system 1A shown in FIG. 8 may include a life evaluation device 50B for evaluating the life which is separated from a controller 5A of an inverter 26A. In the electric motor system 1A, a system including the inverter 26A having the controller 5A which does not evaluate the life may be referred to as a motor system 20.

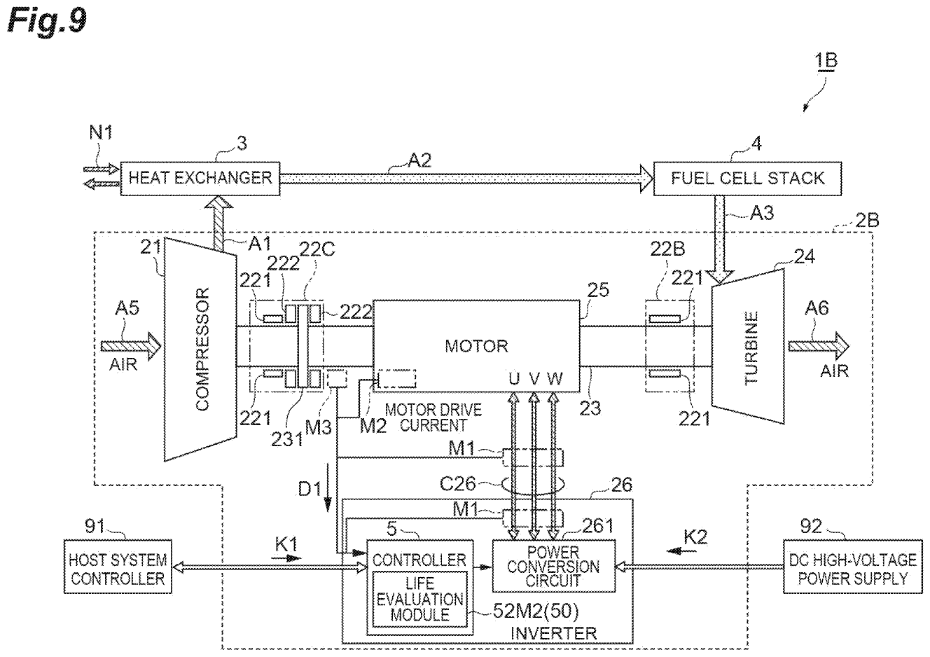

An electric turbocharger 2B constituting an electric motor system 1B shown in FIG. 9 may include an air bearing 22C instead of the air bearing 22A. The air bearing 22C may support a radial load and receive a thrust load. As shown in FIG. 9, the air bearing 22C may have a pair of foils 222 in addition to the foil 221 receiving the radial load. The pair of foils 222 may be arranged so as to interpose a thrust collar 231 provided on the shaft 23 therebetween, and receive the thrust load by gas films generated between the thrust collar 231 and each of the pair of foils 222. The air bearing 22C may be used for evaluating the life based on the contact rotation speed D4, the friction torque D3, the sliding distance D5, and the required stop time D6 described above.

An example electric motor system may include a motor, a hydrodynamic air bearing that rotatably supports a shaft of the motor, a power conversion unit that provides a drive current to the motor, and a life evaluation unit that evaluates a life of the air bearing. The life evaluation unit may include a data input unit that obtains rotation speed history data which is a time history of a rotation speed of the motor, a sliding distance acquisition unit that obtains, using the rotation speed history data, a sliding distance when the shaft is in a state of rotating while being in contact with the air bearing, and an evaluation value calculation unit that obtains a remaining life evaluation value for evaluating the life of the air bearing using the sliding distance.

The electric motor system calculates, in the life evaluation unit, the sliding distance when the shaft is in the state of rotating while being in contact with the air bearing. The life evaluation unit evaluates the life of the air bearing using the sliding distance. Therefore, the electric motor system can evaluate the life of the system including the electric motor attributable to the air bearing.

In some examples the air bearing may have a foil with a thin-plate shape and may rotatably support the shaft along a radial direction of the shaft by a gas film formed between the shaft in rotation and the foil. The evaluation value calculation unit may include a remaining foil thickness acquisition unit that obtains a remaining foil thickness of the foil after wearing based on a wear amount of the foil caused by rotation of the shaft while being in contact with the air bearing as the rotation speed of the shaft decreases. Accordingly, it is possible to evaluate the life of the air bearing supporting the shaft in the radial direction using the thickness of the foil.

In some examples, the air bearing may have a foil with a thin-plate shape and may rotatably support the shaft along an axial direction of the shaft by a gas film formed between a thrust collar provided on the shaft in rotation and the foil. The evaluation value calculation unit may include a remaining foil thickness acquisition unit that obtains a remaining foil thickness of the foil after wearing based on a wear amount of the foil caused by rotation of the shaft while being in contact with the air bearing as the rotation speed of the shaft decreases. Accordingly, it is possible to evaluate the life of the air bearing supporting the shaft in the thrust direction using the thickness of the foil.

In some examples, the evaluation value calculation unit may include a wear amount conversion coefficient acquisition unit that obtains a wear amount conversion coefficient for converting the sliding distance into the wear amount of the foil when the wear amount of the foil is defined as a function having the sliding distance as a variable. Accordingly, the foil wear amount can be obtained from the sliding distance.

In some examples, the wear amount conversion coefficient acquisition unit may obtain the wear amount conversion coefficient based on at least one of a required stop time required to reach a state where rotation of the shaft is stopped from a predetermined rotation state after transitioning from a state where the drive current is provided from the power conversion unit to the motor to a state where the drive current is stopped, and a contact rotation speed which is a rotation speed at which the shaft whose rotation speed decreases starts to contact the foil in the state where the drive current is stopped. Accordingly, it is possible to reflect an operation status in the calculation of the wear amount of the foil.

In some examples, the life evaluation unit may have a friction torque acquisition unit that obtains a friction torque between the air bearing and the shaft using the rotation speed history data, and a contact rotation speed acquisition unit that obtains the contact rotation speed using the friction torque. Accordingly, it is possible to easily obtain the contact rotation speed for obtaining the sliding distance.

An example life evaluation device may be configured to evaluate a life of a motor system. The motor system may include a motor, a hydrodynamic air bearing that rotatably supports a shaft of the motor, and a power conversion unit that provides a drive current to the motor. The life evaluation device may include a data input unit that obtains rotation speed history data which is a time history of a rotation speed of the motor, a sliding distance acquisition unit that obtains, using the rotation speed history data, a sliding distance when the shaft is in a state of rotating while being in contact with the air bearing, and an evaluation value calculation unit that obtains a remaining life evaluation value for evaluating the life of the air bearing using the sliding distance.

An example life evaluation method may include evaluating a life of a motor system. The motor system may include a motor, a hydrodynamic air bearing that rotatably supports a shaft of the motor, and a power conversion unit that provides a drive current to the motor. The life evaluation method may include a step of obtaining rotation speed history data which is a time history of a rotation speed of the motor, a step of obtaining, using the rotation speed history data, a sliding distance when the shaft is in a state of rotating while being in contact with the air bearing, and a step of obtaining a remaining life evaluation value for evaluating the life of the air bearing using the sliding distance.

An example life evaluation program may be configured to evaluate a life of a motor system. The motor system may include a motor, a hydrodynamic air bearing that rotatably supports a shaft of the motor, and a power conversion unit that provides a drive current to the motor. The life evaluation program may cause a computer to operate as a data input unit that obtains rotation speed history data which is a time history of a rotation speed of the motor, a sliding distance acquisition unit that obtains, using the rotation speed history data, a sliding distance when the shaft is in a state of rotating while being in contact with the air bearing, and an evaluation value calculation unit that obtains a remaining life evaluation value for evaluating the life of the air bearing using the sliding distance.

An example electric motor system (1) may include: a motor (25) including a shaft (23); a hydrodynamic air bearing (22A, 22B) that rotatably supports the shaft; an inverter (26) configured to supply a drive current to the motor; and a controller (50). The controller (50) may be configured to: calculate a sliding distance (D5) over which the shaft (23) slides relative to the air bearing (22A, 22B) while the shaft (23) is both rotating and in contact with the air bearing (22A, 22B), based on rotation speed history data (D1) that is a time history of a rotation speed of the motor; and calculate a remaining life evaluation value (D11) for evaluating a life of the air bearing (22A, 22B) based on the sliding distance (D5).

In some examples, the air bearing (22A, 22B) may include a foil (221) with a thin-plate shape disposed around the shaft (23), and is configured to rotatably support the shaft (23) along a radial direction of the shaft (23) by a gas film formed between the shaft (23) and the foil (221) during rotation of the shaft (23). Calculating the remaining life evaluation value (D11) may include calculating a wear amount (D8) of the foil (221) caused by rotation of the shaft (23) while being in contact with the foil (221) when the rotation speed of the shaft (23) decreases, based on the sliding distance (D5).

In some examples, calculating the remaining life evaluation value (D11) may further include calculating a wear amount conversion coefficient (D7) that converts the sliding distance (D5) into the wear amount (D8) of the foil (221), provided that the wear amount (D8) of the foil (221) is defined as a function having the sliding distance (D5) as a variable. Calculating the wear amount (D8) of the foil (221) may include calculating the wear amount (D8) of the foil (221) by multiplying the sliding distance (D5) by the wear amount conversion coefficient (D7).

In some examples, calculating the wear amount conversion coefficient (D7) may include calculating the wear amount conversion coefficient (D7) based on at least one selected from the group of: a required stop time (D6) required to reach a state where rotation of the shaft (23) is stopped from a predetermined rotation state after transitioning from a state where the drive current is provided from the inverter (26) to the motor (25) to a state where the drive current is stopped; and a contact rotation speed (D4) which is a rotation speed at which the shaft (23) whose rotation speed decreases starts to contact the foil (221) in the state where the drive current is stopped.

In some examples, the shaft (23) includes a thrust collar (231) provided on an outer peripheral surface of the shaft (23). The air bearing (22A, 22B) may include a foil (222) with a thin-plate shape disposed around the thrust collar (231), and be configured to rotatably support the shaft (23) along an axial direction of the shaft (23) by a gas film formed between the thrust collar (231) and the foil (222) during rotation of the shaft (23). Calculating the remaining life evaluation value (D11) may include calculating a wear amount (D8) of the foil (222) caused by rotation of the thrust collar (231) while being in contact with the foil (221) when the rotation speed of the shaft (23) decreases, based on the sliding distance (D5).

In some examples, calculating the sliding distance (D5) may include: calculating a friction torque (D3) between the air bearing (22A, 22B) and the shaft (23) based on the rotation speed history data (D1); calculating a contact rotation speed (D4) based on the friction torque (D3), the contact rotation speed (D4) being a rotation speed at which the shaft (23) whose rotation speed decreases starts to contact the foil (221) in the state where the drive current is stopped; and calculating the sliding distance (D5) based on the contact rotation speed (D4).

In some examples, the shaft (23) may be spaced apart from the air bearing (22A, 22B) while the shaft (23) is rotating during a first period of operation. A rotation speed of the shaft (23) may decrease to a contact rotation speed (D4) due to a deceleration of the rotation of the motor (25), causing the shaft (23) to come into contact with the air bearing (22A, 22B). The rotation speed of the shaft (23) may decrease from the contact rotation speed (D4) to zero during a second period of operation. The sliding distance (D5) may include a distance over which the shaft (23) slides relative to the air bearing (22A, 22B) while the shaft (23) is both rotating and in contact with the air bearing (22A, 22B) during the second period of operation, until the rotation speed of the shaft (23) reaches zero.

In some examples, calculating the sliding distance (D5) may include calculating the sliding distance (D5) based on target rotation speed history data (D2). The target rotation speed history data (D2) may include data, of the rotation speed history data (D1), where the rotation speed of the shaft (23) is equal to or lower than the contact rotation speed (D4) during the second period.

An example apparatus (50) for evaluating a life of a hydrodynamic air bearing (22A, 22B) configured to rotatably support a shaft (23) of a motor (25) may include: at least one memory (102, 103) including program code (PG2); and at least one processor (101) configured to cause the apparatus (50) by executing the program code (PG2) to: calculate a sliding distance (D5) over which the shaft (23) slides relative to the air bearing (22A, 22B) while the shaft (23) is both rotating and in contact with the air bearing (22A, 22B), based on rotation speed history data (D1) that is a time history of a rotation speed of the motor; and calculate a remaining life evaluation value (D11) for evaluating the life of the air bearing (22A, 22B) based on the sliding distance (D5).

In some examples, the shaft (23) may be spaced apart from the air bearing (22A, 22B) while the shaft (23) is rotating during a first period of operation. A rotation speed of the shaft (23) may decrease to a contact rotation speed (D4) due to a deceleration of the rotation of the motor (25), causing the shaft (23) to come into contact with the air bearing (22A, 22B). The rotation speed of the shaft (23) may decrease from the contact rotation speed (D4) to zero during a second period of operation. The sliding distance (D5) may include a distance over which the shaft (23) slides relative to the air bearing (22A, 22B) while the shaft (23) is both rotating and in contact with the air bearing (22A, 22B) during the second period of operation, until the rotation speed of the shaft (23) reaches zero.

An example method for evaluating a life of a hydrodynamic air bearing (22A, 22B) configured to rotatably support a shaft (23) of a motor (25) may include: calculating a sliding distance (D5) over which the shaft (23) slides relative to the air bearing (22A, 22B) while the shaft (23) is both rotating and in contact with the air bearing (22A, 22B), based on rotation speed history data (D1) that is a time history of a rotation speed of the motor (25); and calculating a remaining life evaluation value (D11) for evaluating the life of the air bearing (22A, 22B) based on the sliding distance (D5).

In some examples, the shaft (23) may be spaced apart from the air bearing (22A, 22B) while the shaft (23) is rotating during a first period of operation. A rotation speed of the shaft (23) may decrease to a contact rotation speed (D4) due to a deceleration of the rotation of the motor (25), causing the shaft (23) to come into contact with the air bearing (22A, 22B). The rotation speed of the shaft (23) may decrease from the contact rotation speed (D4) to zero during a second period of operation. The sliding distance (D5) may include a distance over which the shaft (23) slides relative to the air bearing (22A, 22B) while the shaft (23) is both rotating and in contact with the air bearing (22A, 22B) during the second period of operation, until the rotation speed of the shaft (23) reaches zero.

In some examples, the air bearing (22A, 22B) may include a foil (221, 222) disposed around the shaft (23). Calculating the remaining life evaluation value (D11) may include calculating a wear amount (D8) of the foil (221, 222) caused by the shaft (23) rotating while being in contact with the foil (221, 222) when the rotation speed of the shaft (23) decreases, based on the sliding distance (D5).

In some examples, the remaining life evaluation value (D11) may indicate an amount of time remaining in the life of the air bearing (22A, 22B) based on when the wear amount (D8) of the foil (221, 222) reaches a predetermined value.

In some examples, the remaining life evaluation value (D11) may indicate a number of remaining times the shaft (23) can contact the foil (221, 222) before being replaced.

In some examples, calculating the remaining life evaluation value (D11) may further include calculating the wear amount (D8) of the foil (221, 222) by multiplying the sliding distance (D5) by a predetermined coefficient (D7).

An example method may further include calculating the coefficient (D7) based on an operating condition of the motor (25) during operation of the motor (25).

In some examples, the operating condition of the motor (25) may include a time required for the rotation speed of the motor (25) to decrease from a predetermined rotation speed to zero after supply of a drive current to the motor (25) is stopped.

In some examples, the operating condition of the motor (25) may include a rotation speed of the shaft (23) at a time point when the shaft (23) contacts the foil (221, 222) as rotation of the shaft (23) slows down after supply of a drive current to the motor (25) is stopped.

In some examples, calculating the sliding distance (D5) may include: calculating a friction torque (D3) between the air bearing (22A, 22B) and the shaft (23) based on the rotation speed history data (D1); calculating, as a contact rotation speed (D4), a rotation speed of the shaft (23) at a time point when the shaft (23) contacts the foil (221, 222) as rotation of the shaft (23) slows down after supply of a drive current to the motor (25) is stopped, based on the friction torque (D3); and calculating the sliding distance (D5) based on the contact rotation speed (D4).

What is claimed is:

1. An electric motor system comprising:
a motor including a shaft;
a hydrodynamic air bearing that rotatably supports the shaft;
an inverter configured to supply a drive current to the motor; and
a controller,
wherein the controller is configured to:
calculate a sliding distance over which the shaft slides relative to the air bearing while the shaft is both rotating and in contact with the air bearing, based on rotation speed history data that is a time history of a rotation speed of the motor; and
calculate a remaining life evaluation value for evaluating a life of the air bearing based on the sliding distance.

2. The electric motor system according to claim 1,
wherein the air bearing
includes a foil with a thin-plate shape disposed around the shaft, and
is configured to rotatably support the shaft along a radial direction of the shaft by a gas film formed between the shaft and the foil during rotation of the shaft, and
wherein calculating the remaining life evaluation value includes calculating a wear amount of the foil caused by rotation of the shaft while being in contact with the foil when the rotation speed of the shaft decreases, based on the sliding distance.

3. The electric motor system according to claim 2,
wherein calculating the remaining life evaluation value further includes calculating a wear amount conversion coefficient that converts the sliding distance into the wear amount of the foil, provided that the wear amount of the foil is defined as a function having the sliding distance as a variable, and
wherein calculating the wear amount of the foil includes calculating the wear amount of the foil by multiplying the sliding distance by the wear amount conversion coefficient.

4. The electric motor system according to claim 3, wherein calculating the wear amount conversion coefficient includes calculating the wear amount conversion coefficient based on at least one selected from the group of:
a required stop time required to reach a state where rotation of the shaft is stopped from a predetermined rotation state after transitioning from a state where the drive current is provided from the inverter to the motor to a state where the drive current is stopped; and
a contact rotation speed which is a rotation speed at which the shaft whose rotation speed decreases starts to contact the foil in the state where the drive current is stopped.

5. The electric motor system according to claim 1,
wherein the shaft includes a thrust collar provided on an outer peripheral surface of the shaft,
wherein the air bearing
includes a foil with a thin-plate shape disposed around the thrust collar, and
is configured to rotatably support the shaft along an axial direction of the shaft by a gas film formed between the thrust collar and the foil during rotation of the shaft, and
wherein calculating the remaining life evaluation value includes calculating a wear amount of the foil caused by rotation of the thrust collar while being in contact with the foil when the rotation speed of the shaft decreases, based on the sliding distance.

6. The electric motor system according to claim 2, wherein calculating the sliding distance includes:
calculating a friction torque between the air bearing and the shaft based on the rotation speed history data;
calculating a contact rotation speed based on the friction torque, the contact rotation speed being a rotation speed at which the shaft whose rotation speed decreases starts to contact the foil in the state where the drive current is stopped; and
calculating the sliding distance based on the contact rotation speed.

7. The electric motor system according to claim 1,
wherein the shaft is spaced apart from the air bearing while the shaft is rotating during a first period of operation,
wherein a rotation speed of the shaft decreases to a contact rotation speed due to a deceleration of the rotation of the motor, causing the shaft to come into contact with the air bearing,
wherein the rotation speed of the shaft decreases from the contact rotation speed to zero during a second period of operation, and
wherein the sliding distance includes a distance over which the shaft slides relative to the air bearing while the shaft is both rotating and in contact with the air bearing during the second period of operation, until the rotation speed of the shaft reaches zero.

8. The electric motor system according to claim 7,
wherein calculating the sliding distance includes calculating the sliding distance based on target rotation speed history data, and
wherein the target rotation speed history data includes data, of the rotation speed history data, where the rotation speed of the shaft is equal to or lower than the contact rotation speed during the second period.

9. An apparatus for evaluating a life of a hydrodynamic air bearing configured to rotatably support a shaft of a motor, the apparatus comprising:
at least one memory including program code; and
at least one processor configured to cause the apparatus by executing the program code to:
calculate a sliding distance over which the shaft slides relative to the air bearing while the shaft is both rotating and in contact with the air bearing, based on rotation speed history data that is a time history of a rotation speed of the motor; and
calculate a remaining life evaluation value for evaluating the life of the air bearing based on the sliding distance.

10. The apparatus according to claim 9,
wherein the shaft is spaced apart from the air bearing while the shaft is rotating during a first period of operation,
wherein a rotation speed of the shaft decreases to a contact rotation speed due to a deceleration of the rotation of the motor, causing the shaft to come into contact with the air bearing,
wherein the rotation speed of the shaft decreases from the contact rotation speed to zero during a second period of operation, and
wherein the sliding distance includes a distance over which the shaft slides relative to the air bearing while the shaft is both rotating and in contact with the air bearing during the second period of operation, until the rotation speed of the shaft reaches zero.

11. A method for evaluating a life of a hydrodynamic air bearing configured to rotatably support a shaft of a motor, the method comprising:
calculating a sliding distance over which the shaft slides relative to the air bearing while the shaft is both rotating and in contact with the air bearing, based on rotation speed history data that is a time history of a rotation speed of the motor; and
calculating a remaining life evaluation value for evaluating the life of the air bearing based on the sliding distance.

12. The method according to claim 11,
wherein the shaft is spaced apart from the air bearing while the shaft is rotating during a first period of operation,
wherein a rotation speed of the shaft decreases to a contact rotation speed due to a deceleration of the rotation of the motor, causing the shaft to come into contact with the air bearing,
wherein the rotation speed of the shaft decreases from the contact rotation speed to zero during a second period of operation, and
wherein the sliding distance includes a distance over which the shaft slides relative to the air bearing while the shaft is both rotating and in contact with the air bearing during the second period of operation, until the rotation speed of the shaft reaches zero.

13. The method according to claim 11,
wherein the air bearing includes a foil disposed around the shaft, and
wherein calculating the remaining life evaluation value includes calculating a wear amount of the foil caused by the shaft rotating while being in contact with the foil when the rotation speed of the shaft decreases, based on the sliding distance.

14. The method according to claim 13, wherein the remaining life evaluation value indicates an amount of time remaining in the life of the air bearing based on when the wear amount of the foil reaches a predetermined value.

15. The method according to claim 13, wherein the remaining life evaluation value indicates a number of remaining times the shaft can contact the foil before being replaced.

16. The method according to claim 13, wherein calculating the remaining life evaluation value further includes calculating the wear amount of the foil by multiplying the sliding distance by a predetermined coefficient.

17. The method according to claim 16, further comprising calculating the coefficient based on an operating condition of the motor during operation of the motor.

18. The method according to claim 17, wherein the operating condition of the motor includes a time required for the rotation speed of the motor to decrease from a predetermined rotation speed to zero after supply of a drive current to the motor is stopped.

19. The method according to claim 17, wherein the operating condition of the motor includes a rotation speed of the shaft at a time point when the shaft contacts the foil as rotation of the shaft slows down after supply of a drive current to the motor is stopped.

20. The method according to claim 13, wherein calculating the sliding distance includes:
calculating a friction torque between the air bearing and the shaft based on the rotation speed history data;
calculating, as a contact rotation speed, a rotation speed of the shaft at a time point when the shaft contacts the foil as rotation of the shaft slows down after supply of a drive current to the motor is stopped, based on the friction torque; and
calculating the sliding distance based on the contact rotation speed.
